(19) United States
(12) Patent Application Publication
(10) Pub. No.: US 2007/0298726 A1
(43) Pub. Date: Dec. 27, 2007

(54) SYSTEM FOR LIMITING USE OF A CELL PHONE

(76) Inventor: Walter B. Fuqua, Corrales, NM (US)

Correspondence Address: CARSTENS & CAHOON, LLP, P O BOX 802334, DALLAS, TX, 75380, US

(21) Appl. No.: 11/425,673

(22) Filed: Jun. 21, 2006

(51) Int. Cl. H04B 1/38

(52) U.S. Cl. 455/73

(57) ABSTRACT

The present invention provides a system and method for controlling access to a computer network via wireless connection. Users of the computer network are provided with a mobile electronic device such as a mobile phone with wireless Internet connectivity. The wireless device also includes a near field communication (NFC) mechanism, such as a RFID antenna. The user is also provided with a control device, preferably contained in a wristband that is worn while using the mobile device. The perimeter of a geographic activation area is defined by one or more radio transmitters. The mobile electronic device can be used to access the computer network only if 1) the control device in the wristband is within the activation area and can received signals from the radio transmitters activates the control device, and 2) the control device is within the range of the mobile device's NFC mechanism, wherein a RFID signal from the control device unlocks a network browser in the mobile electronic device.

### TECHNICAL FIELD

The present invention relates generally to wireless communications and more specifically to a method for restricting the use of a wireless device in a specific area by a specific authorized user.

### BACKGROUND OF THE INVENTION

With the increasing popularity of online gaming and gambling, traditional “brick and mortar” establishments such as casinos and arcades are coming under increasing competition for customer traffic through their establishments. Adding to this competitive pressure is the increasing ease of Internet accessibility via handheld devices such as mobile phones, PDAs, and Blackberries.

In an effort to compete with online gaming many traditional establishments have been developing their own web based sites. However, a key goal of these companies is also to preserve or even increase foot traffic through their physical locations in addition to providing online gaming. Drawing customers to the physical business locations allows the customer to have the best of both worlds by allowing them access both online gaming and traditional gaming that is not available online.

The world wide accessibility of the web presents a difficulty in drawing customers to a specific physical location. Even if a company creates a gaming web site that is unique and stands apart from other web sites in the market, the trick is restricting access to this unique site to those patrons who are at or near the physical business establishment.

### SUMMARY OF THE INVENTION

The present invention provides a system and method for controlling access to a computer network via wireless connection. Users of the computer network are provided with a mobile electronic device such as a mobile phone with wireless Internet connectivity. The wireless device also includes a near field communication (NFC) mechanism, such as a RFID antenna. The user is also provided with a control device, preferably contained in a wristband that is worn while using the mobile device. The perimeter of a geographic activation area is defined by one or more radio transmitters. The mobile electronic device can be used to access the computer network only if 1) the control device in the wristband is within the activation area and can received signals from the radio transmitters activates the control device, and 2) the control device is within the range of the mobile device's NFC mechanism, wherein a RFID signal from the control device unlocks a network browser in the mobile electronic device.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 illustrates a plurality of interconnected heterogeneous networks in which the present invention may be implemented;

FIG. 2A shows a wristband controller containing a low frequency radio receiver antenna and processor switch;

FIG. 2B shows the wristband controller depicted in FIG. 2B also containing a RFID data tag embedded with a public key and a RFID antenna;

FIG. 3 shows the functional relationship between the components of the present invention;

FIG. 4 illustrates the wristband being worn by the user of the wireless device in accordance with a preferred embodiment of the present invention;

FIG. 5 shows the operation of an open channel on a wireless device allowing the authorized user to browse restricted web sites in accordance with an embodiment of the present invention; and

FIG. 6 illustrates how a group of radio transmitters define a geographic activation zone in which an authorized wireless device may be used to access the VPN.

### DETAILED DESCRIPTION

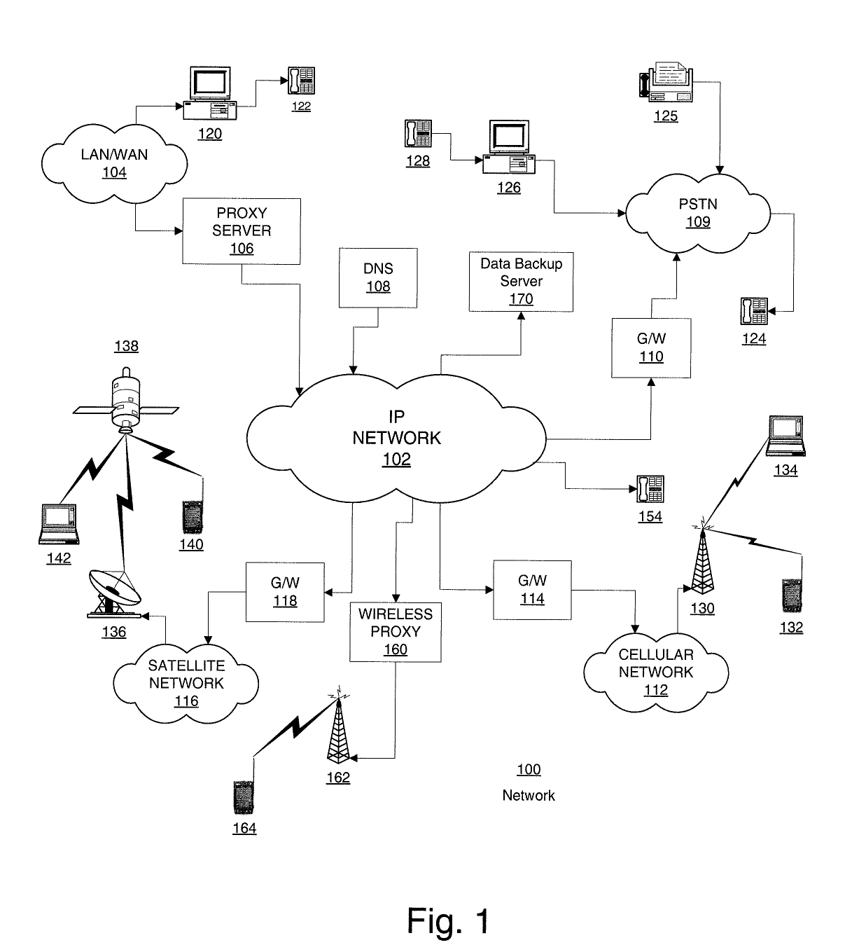

FIG. 1 illustrates a plurality of interconnected heterogeneous networks in which the present invention may be implemented. As illustrated, an Internet Protocol (IP) network 102, a Local Area Network (LAN)/Wide Area Network (WAN) 104, the Public Switched Telephone Network (PSTN) 109, a cellular wireless network 112, and a satellite communication network 116 make up the plurality of heterogeneous networks serviced by the personal mobility system of the present invention.

IP network 102 may be the publicly available IP network, a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/9, and JavaOS. WAP provides interoperability even between different device families. WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on the limited display size and limited input devices available on small, handheld devices. For example, a typical cell phone may have only a 4×10-character display with 16-gray levels and only a numeric keypad plus up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

Wireless Proxy 160 is coupled to IP network 102 and is coupled to a plurality of towers, e.g., 162, which each provide wireless communications with wireless devices such as wireless device 164. Wireless Proxy 160 provides access to IP network 102 to wireless device 164, such as a personal digital assistants (PDA) or a wireless telephone, that may require proprietary or other special protocols in order to communicate with IP network 102. For example, wireless proxy server 160 may be a 3Com server utilizing 3Com protocols for communicating with a Palm VII, a handheld portable computing device available from 3Com Corporation in Santa Clara, Calif.

In a preferred embodiment of the present invention, wireless proxy 160 is a 3Com proxy server supporting communications with Palm VII personal organizer and portable computing device 164 is a Palm VII personal organizer. In this embodiment, communications between wireless proxy server 160 and portable computing device 164 is facilitated by the use of Palm Query Applications (PQAs). A PQA is like a mini-Web site that resides on portable computing device 164. That is, a PQA is a special kind of record database. A typical PQA contains an HTML form or a list of hyperlinks that request additional information either locally—on personal computing device 164—or remotely—on the Internet.

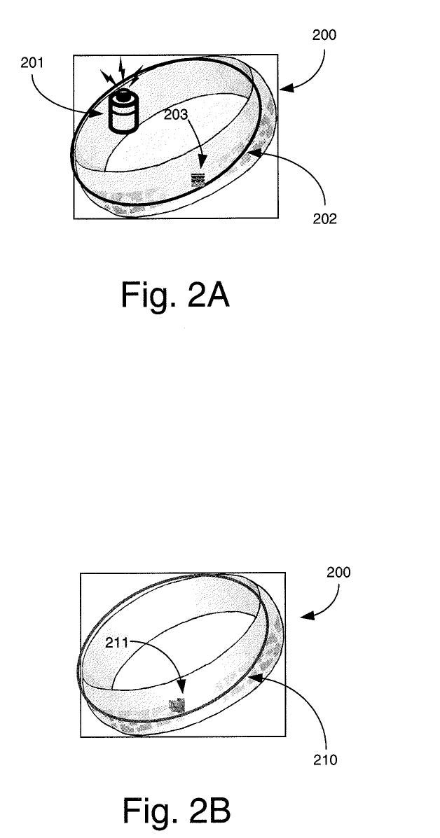

FIG. 2A shows a wristband controller containing a low frequency radio receiver antenna and processor switch. The present invention provides a control device that limits the operation of a Subscriber Identity Module (SIM) card and Web browser function that is established on the SIM card. The control device is fashioned into a wristband or bracelet 200 that can be worn by a user for a specified period of time and thereby permit the activation of a SIM device during an authorized time period as well as restrict such functions within a pre-determined geographic location. The wristband 200 acts as the gatekeeper that links a wireless handheld device to a private computer network.

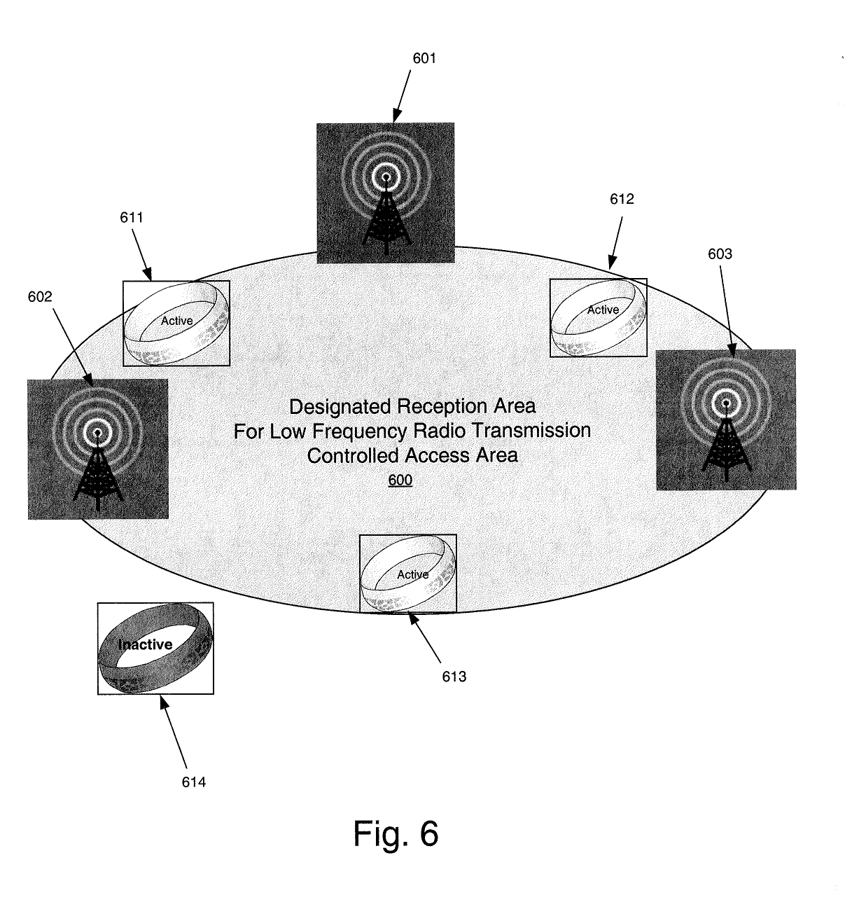

The control device in the wristband 200 comprises two subsystems that together provide access to the closed network. The first subsystem, as shown in FIG. 2A, provides communication between a series of radio transmitters and the wristband controller. The radio transmitters define a geographic activation area in which users may access the closed network, as depicted in FIG. 6. The first subsystem in the control device includes a low frequency antenna 202 that receives activation signals from these transmitters when the wristband 200 is within their transmission range. The signals received via the antenna 202 activate an electronic switch 203, which in turn activates the second subsystem in the control device.

The second subsystem in the wristband controller 200, depicted in FIG. 2B, includes a radio frequency identification (RFID) data tag 211 embedded with a public key and a RFID antenna 210. The switch 203 opens a loop within the wristband 200 which makes available a public key stored within the RFID tag 211. The RFID tag 211 sends the public key to a wireless handheld device via the RFID antenna 210, allowing the wireless device to access the computer network.

A low voltage battery 201 provides power to the wristband 200 and in the preferred embodiment is activated by the clasp of the wristband.

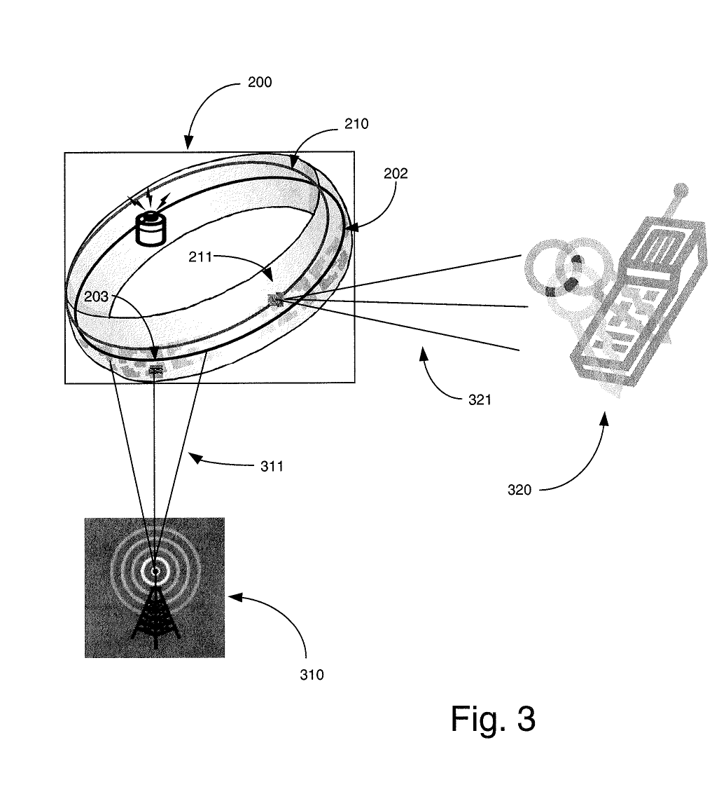

FIG. 3 shows the functional relationship between the components of the present invention. Signals 311 from the radio transmitter 310 are received by the low frequency antenna 202 in the wristband 200, which activates the switch 203. The switch 203 then signals the RFID tag 211 and antenna 210 to send the public key to the handheld device 320. In the present example, the handheld device is a mobile phone with network browsing capabilities. However, any handheld device with wireless network access, e.g., PDA, Blackberry, will work with the present invention.

The wireless device 320 receives the public key in an electronic transmission link 321 between the RFID antenna 210 in the wristband and a Near Field Communication (NFC) receptor (not shown) located within the device 320. NFC is a short-range wireless connectivity standard that uses magnetic field induction to enable communication between devices when they are touched together or brought within a few centimeters of each other. Jointly developed by Philips and Sony, the standard specifies a way for the devices to establish a peer-to-peer (P2P) network to exchange data. NFC operates within the globally available and unregulated radio frequency band of 13.56 MHz and covers a range of 0-20 cm.

The public key unlocks the browser features located in the SIM card of the wireless device 320, which the wireless device uses to browse certain authorized web sites. The present invention can also employ other types of storage devices to simulate the function of the SIM card in wireless devices that traditionally do not use or employ SIM cards, allowing the invention to be used on CDMA or GSM networks for wireless cellular devices.

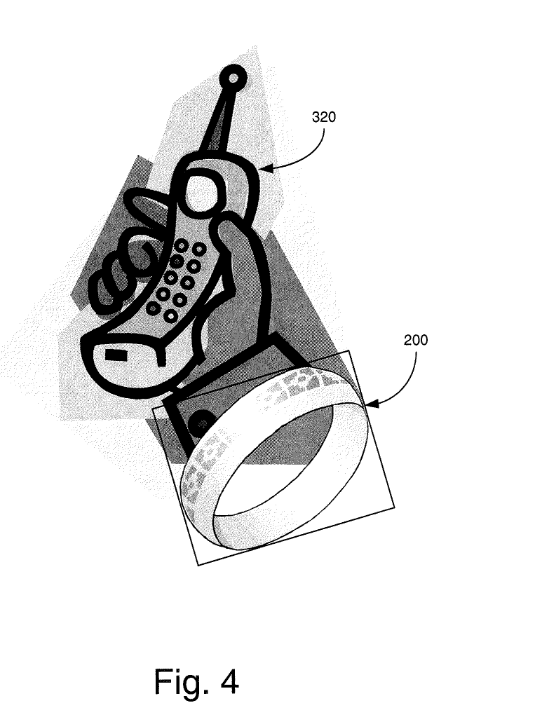

FIG. 4 illustrates the wristband being worn by the user of the wireless device in accordance with a preferred embodiment of the present invention. By placing the control device within a wristband 200, the present invention makes it easy for the user to keep the control device within NFC range of the wireless device 320 by simply wearing the wristband on the arm of the hand holding the wireless device.

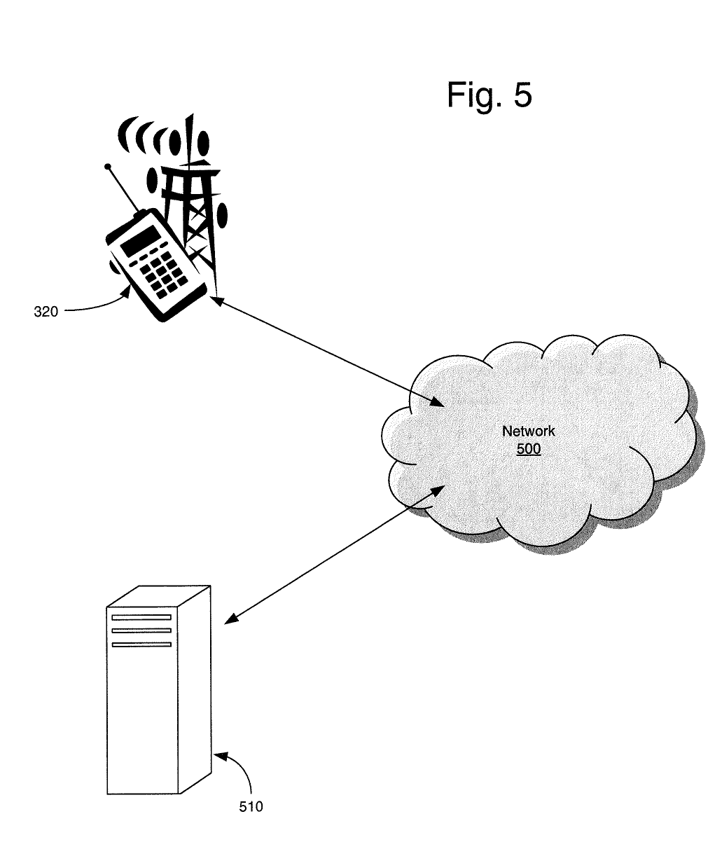

FIG. 5 shows the operation of an open channel on a wireless device allowing the authorized user to browse restricted web sites in accordance with an embodiment of the present invention. Once the browser function of the SIM in the wireless device 320 is unlocked by the public key, the device can connect via computer network 500 to a Systems Operator virtual private network (VPN) server 510. The wireless connection between the handheld device 320 and the network 500 can be made using any of the well known standards in the art such as General Packet Radio Service (GPRS) or WiFi® (IEEE 802.11).

In the preferred embodiment of the invention, the SIM controlled browsing function of the wireless device is restricted to specific authorized sites operated. The purpose of restricting the wireless device is to limit access to the VPN for secure access to an operator's site. This method allows restricted service for many purposes including gaming, gambling, security restricted activities, and geographic restriction for access to data sites. Furthermore, the wireless device may also be restricted to use for a limited period of time.

FIG. 6 illustrates how a group of radio transmitters define a geographic activation zone in which an authorized wireless device may be used to access the VPN. In the present example, three radio towers 601, 602, 603 define the activation zone 600. The present invention may be implemented using fewer or more radio transmitters depending on the operator's needs and the amount of territory to be covered.

As can be seen in the figure, the authorized wristband controllers 611, 612, 613 that are physically located within the activation zone 600 are able to receive signals from the transmitters 601, 602, 603 and become active, ready to send a public key to a paired NFC wireless device within range. Any control device not within the activation zone (e.g., wristband 614) cannot receive the activation signals from the transmitters and therefore remains inactive.

The combination of elements of the present invention place several prerequisites on the user in order to access the restricted web sites:

Remain within the authorized geographic area established by the operator

Keep the wristband on the arm where placed by the operator

Use the authorized/paired wireless device within near proximity to the wristband

Navigate the browser feature of the wireless device to the authorized web sites

Use the wireless device as prescribed by the operator

With the activation of the wristband/bracelet by the operator, the wristband is paired with the operator-issued wireless device and activated for the desired time period. When the user is in compliance with all of the prescribed requirements, the user is able to access prescribed web sites. In one embodiment, the prescribed web sties are previously established by the operator by programming them on the SIM card. The breaching of any of the required elements renders the wireless device inoperable until such time as when the user complies with the necessary conditions.

Upon expiration of the authorized time period, the wristband becomes inactive and unable to permit further access to the network. Any tampering with the wristband or by the user, including attempting to remove it, will also disable the wristband and terminate access to the network.

A typical example of the present invention in practice is a VPN for online gambling that is accessible through a host casino. Online gambling through the World Wide Web has become increasingly popular. However, these games may be accessed from anywhere in the world that has Internet access. Casinos may desire to establish gambling web sites that are specially customized and can only be access at the casino itself. In this situation, the casino may deploy multiple low power transmitters that restrict the activation zone to the casino and its associated hotel. Patrons wishing to access the casino's gambling web sites would be issued a wristband controller and a paired wireless phone that had the web sites programmed into its SIM card. In order to access the casino VPN with the wireless phone, the user must wear the wristband while operating the phone and remain in the casino or hotel.

A similar application may be used for video game arcades. The set up would operate the same as for the casino, except the content of the restricted web sites would be video games rather than gambling.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A system for controlling access to a computer network via wireless connection, the system comprising:
(a) a mobile electronic device that can access computer networks via wireless connection, wherein the mobile electronic device includes a near field communication (NFC) mechanism;
(b) a control device; and
(c) at least one radio transmitter with a transmission range that defines the perimeter of a geographic activation area;
wherein said mobile electronic device can access the computer network only if:
(i) the control device is within said activation area, wherein a signal from the radio transmitter activates the control device; and
(ii) the control device is within the defined range of the NFC mechanism in the mobile electronic device, wherein a NFC signal from the control device unlocks a network browser in the mobile electronic device.

2. The system according to claim 1, wherein the mobile electronic device is a mobile phone.

3. The system according to claim 1, wherein the control device is contained in a wristband worn by a user of the mobile electronic device.

4. The system according to claim 1, wherein the network browser in the mobile device is controlled by a Subscriber Identity Module (SIM) in the mobile electronic device.

5. The system according to claim 4, wherein the network browser in the mobile electronic device is limited to network sites that are pre-programmed into the SIM.

6. The system according to claim 1, wherein the NFC signal from the control device to the mobile electronic contains a public key that unlocks the browser.

7. The system according to claim 1, wherein the control device communicates with the NFC mechanism in the mobile electronic device via radio frequency identification (RFID).

8. A method for controlling access to a computer network via wireless connection, the method comprising the steps of:
(a) providing a network user a mobile electronic device that can access computer networks via wireless connection, wherein the mobile electronic device includes a near field communication (NFC) mechanism;
(b) providing said network user a control device; and
(c) establishing the perimeter of a geographic activation area defined by the transmission range of at least one radio transmitter;
wherein said mobile electronic device can access the computer network only if:
(i) the control device is within said activation area, wherein a signal from the radio transmitter activates the control device; and
(ii) the control device is within the defined range of the NFC mechanism in the mobile electronic device, wherein a NFC signal from the control device unlocks a network browser in the mobile electronic device.

9. The method according to claim 8, wherein the mobile electronic device is a mobile phone.

10. The method according to claim 8, wherein the control device is contained in a wristband worn by the user.
